(19) United States
(12) Patent Application Publication
(10) Pub. No.: US 2009/0053513 A1
(43) Pub. Date: Feb. 26, 2009

(54) High-strength polypropylene-base barrier film for packing purposes, method for the production and the use thereof

(75) Inventors: Helmut Enzinger, Siegsdorf (DE); Lajos Edward Keller, Luxembourg (LU)

Correspondence Address: NIXON & VANDERHYE, PC, 901 NORTH GLEBE ROAD, 11TH FLOOR, ARLINGTON, VA, 22203, US

(73) Assignee: BRUCKNER MASCHINENBAU GmbH, Siegsdorf (DE)

(21) Appl. No.: 11/919,790

(22) PCT Filed: Feb. 23, 2006
(86) PCT No.: PCT/EP2006/001659

§ 371 Date: Nov. 2, 2007

(30) Foreign Application Priority Data
May 4, 2005 (DE) 10 2005 020 913.0

(51) Int. Cl. B32B 27/08; B29C 47/06

(52) U.S. Cl. 428/339; 428/476.9; 264/173.1

(57) ABSTRACT

The invention relates to a high-strength and brilliant quality barrier film for packing purposes, in particular for food packaging embodied in the form of a multilayer film based on of at least one carrier layer consisting of a biaxially oriented polypropylene film (PP-film) and of a functional layer based on amorphous and partially-crystalline polyamide (PA) which is produced by simultaneously stretching a primary multilayer coextruded film, wherein said polyamide functional layer consists of an external film layer and a central internal layer placed between two carrier layers. Methods for the production of the inventive film and the uses thereof are also disclosed.

This invention relates to a high-strength barrier film for packing purposes, particularly for the packing of food products, beverages, tobacco and other sensitive products, embodied in the form of a multilayer film whose mechanical properties are largely determined by a biaxially orientated film for which a crystallizable polypropylene is used as a film-forming polymer and which also has on its surface or if necessary in an internal layer, as a functional layer or barrier, a co-extruded layer based on an amorphous or partially crystalline polyamide (PA) or a mixture of such a polyamide with ethylene vinyl alcohol copolymers (EVOHs).

The invention further relates to a method for producing such a film and to the use of this film for packing purposes, particularly for the packaging of food products, beverages and tobacco, use being made of the excellent optical properties, strength properties and barrier properties of the film.

Packaging materials based on plastic films are now an intrinsic part of modern life. A variety of requirements are imposed on such plastic films, depending on the products to be packed. In the case of plastic films for the packaging of food products, beverages and tobacco, considerable importance is attached to properties which guarantee the durability of the packed food product, beverage or tobacco through the sales channels until it is consumed by the end consumer. Additional requirements imposed on films derive from the fact that the packaging material must generally be provided with information on the packed products, data on the manufacturer etc. and is also an advertising medium which should have an attractive, sales promoting appearance.

Part of the quality assurance provided by the plastic film of the packaging material is to protect a number of products from aroma losses and to prevent the escape of odor-intensive substances and, in numerous cases, protect against oxygen in the air and/or humidity and/or moisture losses from the product. Films with such properties are also known as barrier films or barrier layer films.

To guarantee the printability of the films the film surface must have certain properties, including adequate surface tension. The appearance and the haptics of the film are also important properties for sales purposes, i.e. their surface quality and rigidity, or their dimensional stability and rigidity of softness.

Since the various requirements mentioned cannot normally be met simultaneously by a single film material, it is necessary to subject a film material to a special surface treatment and/or coating treatment and/or guarantee the required properties by using instead of single films multilayer films in which different layers perform different tasks.

Multilayer films generally comprise a carrier layer of a film-forming main polymer, determining the most important mechanical properties, external or internal barriers for obtaining the desired barrier properties and external layers which guarantee the printability, coatability or sealability required to produce closed packaging materials or laminates.

If stringent requirements are imposed on the packaging films, films based on polyesters (PET; polyethylene terephthalate) are now frequently used in the food, beverage and tobacco sector. These films have high strength, good optical properties and good coatability for brilliant metal films, particularly of aluminum, or for transparent ceramic coatings, particularly of SiOx or AlOx. The thin metal or ceramic films give the films barrier properties that meet stringent requirements, particularly in terms of water vapor transmission rate (WVTR; measured in g/(m² d) or g/(m²24 h)) and oxygen transmission rate (OTR, measured in cm³/(m² dbar) or cm³/(m²24 h) at an atmospheric pressure of 1 bar). In order to guarantee the weldability or sealability of the films required for producing the packaging material, they normally also have an additional external polyolefin layer, for example a polyethylene layer provided over the metallisation or ceramic coating, for example of HDPE or LDPE.

Although these polyester films meet high quality requirements, they suffer from the disadvantage, among other things, that polyester polymers are relatively expensive and have a relatively high density.

An attempt is therefore made to make use of polyolefin films instead of polyester films, especially polypropylene films, which can be produced comparatively cheaply in large quantities as biaxially orientated polypropylene films (BOPP films) and which have high strength and are lighter than polyester films. However, polypropylene films as such do not have the barrier properties required for demanding applications, nor can they easily be provided with brilliant aluminum or clear ceramic coatings without pre-treatment. For this purpose a surface treatment of the orientated polypropylene films is required in the form of a corona, flame or plasma treatment, in which the surface tension or surface polarity important for wettability is increased. However, these surface treatments in BOPP films result in a disturbing odor development, which is familiar to persons skilled in the art as a “Maggi-like” odor. Metal or ceramic coated polypropylene films are also less suitable for applications in which the consumers are used to or expect clear brilliant, cellophane-like, i.e. rustling or crumpling packaging materials.

EP 0 546 709 A1 and the corresponding U.S. Pat. No. 5,591,520 disclose the application of a thin co-extruded layer based on an amorphous or, if necessary, semicrystalline polyamide that is bonded by means of a special adhesive layer to the polypropylene-base film which considerably increases the wetting surface tension of such a coated polypropylene film so that aluminum layers with very good adhesion can be steamed on. According to the exemplary embodiment of EP 0 446 709 A1, a co-extrusion of a three-layer multilayer film takes place with a first layer of an amorphous polyamide (product of condensation of hexamethylene-diamine with isophthalic acid anhydride), a second layer which forms the actual carrier film layer and consists essentially of a polypropylene homopolymer, to which is added a polypropylene modified with maleic acid anhydride to improve the adhesion of the polyamide layer and a third layer which serves as a layer for weldability or sealability and consists of an ethylene-propylene-1-butene-terpolymer known for this purpose.

The co-extruded melt is solidified on a chill roll to form a primary multilayer film and is then sequentially stretched firstly in the machine direction (MD) to 3.5 times its original length, then in the transverse direction (TD) to 8 times its original width (elongation ratio of 28 or surface enlargement to 28 times). The polyamide side of the film obtained had a wetting surface tension of over 50 dynes/cm. The film was provided in the normal way with an aluminum layer by vacuum deposition up to an optical density of 2.5.

After aluminum deposition, the film obtained had a water vapor transmission rate (WVTR) of 0.02 g/100 inches²/24 h or—converted—0.31 g/m² d and an oxygen transmission rate (OTR) of 1.0 cm³/100 inches²/24 h or 15.5 cm³/(m² d).

In particular, the oxygen transmission rate of the metallized film far exceeds that required for high quality modern barrier films and is, for example, below 0.1 cm³/m²/24 h in polyester-base metallized films.

There is no indication of the strength and appearance of the film obtained according to EP 0 546 709 A1. However, it is obvious to the person skilled in the art familiar with the biaxial orientation of polypropylene film that during the sequential stretching described, where slight stretching in the machine direction (MD) is followed by more intense stretching in the transverse direction (TD), the strength properties of the biaxially stretched polypropylene film obtained (tensile strength, modulus of elasticity) in the MD direction are lower than in the TD direction, typical values for the tensile strength under the production conditions indicated being approximately 140 N/mm² in the MD direction and 280 N/mm² in the TD direction. Accordingly the elongation at rupture in such films is higher in the MD direction (typically 150 to 250%) than in the TD direction (50 to 60%). Ratios similar to those for tensile strength also apply to the modulus of elasticity.

It could not be established that aluminum coated films according to EP 0 546 709 A1 were ever tested or used commercially to any appreciable extent. Data on the appearance, other film properties and data on the aroma and odor retention of the films are as hard to find in the description of EP 0 546 709 A1 as data on preferred applications of the disclosed orientated polypropylene films with polyamide coating and aluminum deposition. Furthermore, the possibility that the process engineering limitations of the elongation ratios may lead to intolerably poor thickness tolerances cannot be ruled out.

The publication DE 699 16 111 T2 discloses a barrier film for packing purposes embodied in the form of a multilayer film based on at least one carrier core layer in the form of an ethylene vinyl alcohol copolymer film with at least two external layers of ethylene homo- or copolymer, which is produced by simultaneous stretching of a co-extruded multilayer primary film. Such a film may contain as additional layer(s), e.g. for increasing the total mass and/or for improving shrinkage and/or the mechanical properties etc. one or more intermediate layer(s) based on various other polymers, mention also being made of polyamides. A seven-layer film is described in which a polyamide compound layer is provided on both sides of a core layer with the addition of polyamide, which serves as a softener for the ethylene vinyl alcohol copolymer.

The publication EP 0 311 293 B1 discloses a barrier film for packing purposes, in particular as a barrier against oxygen, nitrogen and carbon dioxide, embodied in the form of a multilayer film based on at least one carrier layer in the form of a polypropylene film (PP film) with at least one co-extruded functional layer based on ethylene vinyl alcohol copolymers (EVOHs).

The object of this invention is to provide high quality, brilliant, i.e. clear and gloss, high-strength packing films with excellent impermeability to aromas and odors, which can also be metallized or provided with clear ceramic coatings, and then has barrier properties, in particular also in terms of the oxygen transmission rate, which lie within the order of magnitude of modern barrier films based on coated polyethylene terephthalate, but which have the cost and weight advantages and production advantages of polypropylene films over polyester films.

Surprisingly the inventors established that this object is achieved if a multilayer film of polypropylene and a polyamide layer are stretched simultaneously and in a non-contact manner with a high elongation ratio corresponding to a surface enlargement of the primary film to approximately 40 to 80 times, so that in the machine direction (MD) strength properties are obtained which are at least the same as, but generally better than those in the transverse direction (TD), and overall a film with high strength is obtained.

Since the inventors were also able to establish, on the test films they produced with external PA layers, that the polyamide layer as such guarantees a high aroma density and odor density of the film, even without an additional coating, and that it also makes a considerable contribution to the total strength and rigidity of the highly stretched polypropylene film, a further related film was developed as a modification which has a polyamide layer in the film core between two layers of orientable polyolefins, e.g. between two identical or, if necessary, different polypropylene layers or, for example, one polypropylene layer and a polypropylene regenerate layer.

The new films according to this invention are reproduced in Claims 1 and 2 of the attached set of claims.

Advantageous designs of one or both films as claimed in Claims 1 and/or 2 are described in the dependent Claims 3 to 20.

Claims 21 to 26 describe advantageous embodiments of methods for producing such films and Claims 27 and 28 relate to the use of films as claimed in Claims 1 to 20 as packing films for food products, beverages and tobacco.

The inventors have established that when a primary film with a basic layer of an orientable polypropylene and a layer of an amorphous or semicrystalline polyamide, or of such a polyamide and a barrier polymer such as ethylene vinyl alcohol copolymer, applied to a basic layer through the mediation of an adhesive layer, is subjected to non-contact simultaneous stretching with a high elongation ratio, a clear film with excellent surface properties, strength values and high gloss (gloss; ASTM 2457) of over 100, and in particular within the range of approximately 101 to 107, and high clarity is obtained. If an aluminum coating or ceramic coating of SiOx or AlOx, is applied by a known method to the external polyamide coat, excellent barrier properties are obtained even with very thin coatings. For example, the application of an aluminum coat in an optimum optical density of 2.3 results in a film with an oxygen transmission rate (OTR) which ranges from 0.05 to 0.5 cm³/m³ d at 23° C. and 75% relative humidity and which is therefore 30 to 300 times better than the film described in EP 0 546 709 A1. The water vapor transmission rates (WVTR; ASTM E 96 at 38° C., 90% relative humidity) of the film metallized in an optimum density of 2.3 are below 0.5 g/m²24 h, values of between 0.3 and 2.5 being obtained before metallizing, according to the surface treatment.

Here in particular elongation ratios ranging from 40 to 80 (calculated as the product of the stretching in the MD and TD directions) are selected as the high elongation ratio. In this case the primary multilayer foil is stretched in the machine direction (MD) to at least 6 times its length, stretching of the primary multilayer film taking place simultaneously in MD to at least 7 times and in the transverse direction (TD) to less than 7 times, preferably in MD to more than 8 times, preferably to at least 9 times, and in TD to less than 8 times its length.

The inventors attribute the drastic improvement, e.g. in the oxygen barrier of the metallized film according to the invention, to the fact that in the sequential stretching in the longitudinal direction, described in EP 0 546 709 A1, using the normal rolling devices, the formation of a smooth surface of the polyamide layer is prevented and this layer is no longer smoothed in the transverse direction, even during subsequent stretching, since polyamides have too high melting points and subsequent surface improvement by the formation of an intermediate fusible surface layer is not possible. The surface defects in the polyamide layer produced during sequential stretching mean that in the subsequent application of a metallisation no fault-free dense metal layer can be formed, which is essential for high barrier properties, particularly a high barrier action against oxygen.

Moreover, the inventors established that at the high elongation ratios that become possible by simultaneous stretching, a film with a high strength is obtained which is similar to a cellophane film in many of its properties, that is for example rustling/crumpling, with brilliant clarity and high gloss. Here the strength values in the direction corresponding to the MD of the production are at least the same as, but generally better than in the direction perpendicular to it, which corresponds to the TD (transverse direction).

Thus the tensile strength (ASTM D 822) of the film MD ranges from 170-280 N/mm² and in TD from 130-215 N/mm² and its elongation at rupture (ASTM D 82) in MD ranges from 50-120% and in TD from 100-220%. Values in the range of between approximately 2750 N/mm² and approximately 3630 N/mm² were measured as values of the modulus of elasticity (ASTM D 882) for the test films in MD, whilst the corresponding values in TD ranged from over approximately 1900 N/mm² to approximately 2600 N/mm².

Because of the inherent strength properties of the simultaneously stretched foil according to the invention, particularly with reference to the ratio of the strengths in both main directions of the film, and because of its gloss, the person skilled in the art is immediately able to distinguish a simultaneously highly stretched film according to the invention from a film whose production is described in EP 0 547 709 A1.

The preferred method for carrying out the simultaneous stretching is stretching on a simultaneous stretching system with linear motor operation (LISIM®). However, the less advantageous methods of simultaneous stretching with a mechanical simultaneous stretching system (MSO; Mechanical Simultaneous Orienter; with chain operation) and of production as hose film with stretching by the BUBBLE or DOUBLE BUBBLE method, are also to be included within the scope of the invention. With production in the form of a multilayer hose film, the layer composite is preferably arranged so that the PA layer forms the inside of the hose stretched by inflation.

To obtain optimum film properties, the inventors have established that it is advantageous, in the simultaneous stretching of a flat film, e.g. by the LISIM® technique, to co-extrude the polymers during the production of the multilayer film so that the polyamide layer, when it represents an external layer, comes directly into contact with the chill roll, since this avoids surface disturbances produced by the air cutter acting on the other side of the melt and so that problems resulting from the accumulation of polyamide melt on the edge of the extrusion dies are also eliminated.

If the polyamide film forms an external layer of the primarily produced multilayer film, its thickness should not be too high and should be below 5 μm, preferably below 2.5 μm, otherwise the inherent strength of the polyamide layer, which is increased during stretching, causes the film to roll inwards or twist during cooling. On the other hand the polyamide layer of the stretched film can be kept extraordinarily thin, for example in the range of approximately 0.1 μm or even less, if it is particularly important to improve the printability or writeability of the film obtained, and if the strength and tightness properties are of subordinate importance. Layer thicknesses of the external PA layer of less than 0.5 μm down to 0.1 μm are selected as reference points when printability and writeability are the only important considerations. In vacuum coating, in particular metallisation with aluminum, values ranging from 0.5 to 1.0 μm produce excellent barriers, and values ranging from 1.0 to 2.0 μm produce excellent results in terms of odor and aroma protection and the barrier effects.

A film which has as its main structural elements a carrier layer of a simultaneously biaxially stretched polypropylene and a co-extruded and simultaneously stretched polyamide layer generally has further layers. Thus an adhesion improving layer, which may for example be a layer of a modified polypropylene such as that described in EP 0 546 701 A1, is generally provided between the polypropylene layer and the polyamide layer.

Moreover, a thermoplastic weldable or sealable polyolefin layer is preferably arranged on the side of the film opposite the polyamide layer, which polyolefin layer may consist of a polymer normally used and known for this purpose, for example a polyethylene-propylene-butene-terpolymer or a similar polymer, and which, if necessary, may be connected to the polypropylene layer by means of an intermediately stored adhesion layer or an intermediate layer facilitating the removeability of the basic film.

The inventors have established that the external polyamide layer is well suited for direct metallisation or ceramic coating because of its high surface quality. However, it is also possible to subject this layer to normal corona, plasma or flame treatment, and hence further modify the surface properties. Compared to a corresponding treatment of an orientated polypropylene film, it is established here that no disturbing odor develops. However, it was also established that a flame treatment impairs the quality of subsequent metallisation and is therefore generally less advantageous. Since it transpired that the polyamide layer as such, even without additional coating, gives rise to a high aroma and odor activity of the film and that it can also substantially improve the rigidity and mechanical properties of the multilayer barrier film obtained, a further film was created in which, as claimed in claim 2, the polyamide layer is arranged in the core of a multilayer barrier film in which it is covered on both sides with the same or different polypropylene carrier layers. In this case the adhesive layers are extruded on both sides of the polyamide layer and additional functional layers, generally of propylene-ethylene copolymers or propylene-ethylene-butylene terpolymers, are usually applied to the external layers of the polypropylene layers, which copolymers or polymers enable the surface treatment and/or weldability and sealability of the films to be improved. If the polyamide layer is arranged in the core of a multilayer film, it may be considerably thicker than if it is arranged as an external layer, i.e. it may have a thickness of up to approximately 10 μm, since it does not result in distortion, swelling or inward rolling of the film when arranged in the center of the thicker film.

When polypropylene is referred to in the context of this application, what is meant is a high quality polypropylene that is orientable by biaxial stretching, which is preferably a polypropylene homopolymer with high isotacticity. However, other polypropylene qualities used for comparable purposes may also be employed, for example those which contain a low proportion of other copolymerized monomers. In EP 0 546 709 B1 reference is also made to the definition of the term “polypropylene” for the purposes of this application.

The same applies with regard to the definition of the term “amorphous polyamide” or “semicrystalline polyamide” and/or with regard to the definition of the adhesive layer generally required between the polypropylene and the polyamide layer. Reference is also made with regard to these components to the corresponding material data in EP 0 546 709 A1 for the purposes of this invention in addition to the material data in the following examples. Moreover, all the layers may contain different normal additives, according to the intended application of the film, of which mention may be made, for example, of mineral or organic additives for forming micro-cavities, fillers, absorption agents, UV and light screening agents, dyes and covering pigments.

The invention is explained in further detail in the following with reference to exemplary embodiments, the person skilled in the art deducing further information on the invention and its advantages from the method conditions, materials and film properties described.

In the examples, Examples 1 to 15 describe the production of a multilayer film with a total of 5 layers, with an external polyamide layer whose layer structure is explained in principle in greater detail before Example 1.

Examples 16 to 18 describe a 7-layer multilayer film with a central polyamide layer whose general structure is explained before Example 16.

The properties of the multilayer barrier films obtained in all Examples 1 to 18 are summarized in the attached table with test results.

The materials indicated in the examples with their commercial names are materials of the following type:

| | |
|---|---|
| HP 522 H: | isotactic polypropylene homopolyer “Moplen ®” |
| | HP 522 H from Basell; |
| PA 3426 | DuPont ™ Selar ® PA 3426 amorphous polyamide |
| | resin; |
| Bynel ® 21 | anhydride-modified ethylene acrylate resin from |
| E 781: | DuPont ™; |
| Bynel ® 50 | anhydride-modified polypropylene resin from |
| E 739: | DuPont ™; |
| TD 110 BF: | C2/C4-terpolymer-PP resin Borseal ™ TD110BF from |
| | Borealis A/S, Denmark; |
| TD 120 BF: | C2/C4-terpolymer-PP resin Borseal ™ TD120BF from |
| | Borealis A/S, Denmark. |

### EXAMPLES

### Before Example 1

In Examples 1 to 15, 5-layer multilayer barrier films with a polyamide layer were produced as an external layer, in which an extrusion was carried out by means of a 5-layer wide slot melting die onto a chill roll and in which the 5-layer primary film formed on the chill roll was stretched immediately on a laboratory LISIM® stretching system from Brückner simultaneously, as indicated in the examples.

The layer arrangement of the melts for producing the multilayer film was in this case produced by means of the following die arrangement with the feed devices indicated:

Layer A—External layer, air cutter side: 35 mm single screw extruder;

Layer B—Intermediate layer: 50 mm single screw extruder with melting pump;

Layer C—Core layer: 55 mm two-screw extruder with melting pump;

Layer D—Intermediate layer: 43 mm single screw extruder with melting pump;

Layer E—External layer, chill roll side: 35 mm single screw extruder.

It must be pointed out that the designation of layers A to E is predetermined by the arrangement of the wide slot dies for the melting extrusion and its position relative to the chill roll and the opposing air cutter.

In Examples 1 to 5 the polyamide layer is extruded as layer A, whilst in Examples 6 to 15 the polyamide layer is extruded as layer E on the chill roll side, which is preferable.

### Example 1

Materials and the operating conditions of the five extruders were as follows:

Layer A: PA 3426, extruder with a feed rate of 30 rpm.

Layer B: Bynel 21E781; extruder with melting pump at a feed rate of 30 rpm

Layer C: HP 522 H; core extruder with melting pump with a feed rate of 45.7 rpm.

Layer D: HP 522 H; extruder with melting pump with a feed rate of 8 rpm.

Layer E: TD 110 BF, extruder with a feed rate of 26 rpm.

The primary film obtained after co-extrusion of the 5-layer melt was orientated under the conditions that were optimized for the simultaneous orientation of biaxially orientated polypropylene films (S-BOPP films), with 8 times stretching in the machine direction (MD) and 7 times stretching in the transverse direction (TD), according to the enlargement of a grid printed onto the base film before stretching. A film with a total thickness of 20 μm was obtained and the thickness of the polyamide layer (layer A) was approximately 1.2 μm.

The film was subjected to corona treatment of the surface of the polyamide layer (A) under standard conditions for BOPP films.

The film obtained was of brilliant appearance and rustled. The wetting surface tension was measured at more than 55 dynes/cm without the “Maggi-like” odors typical of corona-treated BOPP films being perceptible.

### Example 2

The film was produced as described in Example 1, except that the feed rate of the extruder used was reduced to 15 rpm for extruding layer A. The thickness of the external polyamide layer (layer A) was approximately 0.6 μm. The film obtained had the same brilliant appearance and the same high surface tension as in Example 1.

### Example 3

The film was manufactured as in Example 2, but in this case no corona treatment was carried out. The appearance of the film was as in the preceding examples and the surface tension of the freshly produced film was approximately 50 dynes/cm.

A composite roll was produced on a cutting machine with the samples from Examples 1, 2 and 3 and all three films on the roll were metallized up to an optimum density of 2.3 under identical conditions, the standard conditions for metallizing a BOPP film in a metallizer from Applied Films. It was established that the metal adhesion for all three samples metallized under the same conditions was excellent.

### Example 4

The film was produced as in Example 1, except that the feed rate of the extruder of layer A was increased to 64 rpm, which resulted in a thickness of the PA layer on the orientated S-BOPP film of approximately 2.5 μm.

The film had the same brilliant appearance as previously, but because of the high rigidity of the external polyamide layer (layer A), with the high surface tension, it displayed a high roll-in tendency.

### Example 5

The film was produced essentially as in Example 1, except that a mixture of 50% Bynel 21 E 781 and 50% HP 522 HPP was used for layer B (adhesion layer).

The film obtained had an improved appearance, very good structural integrity and excellent adhesion of the polyamide layer (layer A).

Since it was observed that there was an accumulation of polyamide on the edge of the outer hot-melt die which, combined with the air cutter action, resulted in a discernible stripiness of the film surface, the feed of the hot-melt dies for layers A to E in Examples 6 to 15 below was reversed so that the polyamide layer now formed the side of the melt directly in contact with the chill roll. The polyamide layer is therefore layer E in Examples 6 to 15 below.

### Example 6

5 different polymers were co-extruded by 5 wide slot dies in the following arrangement:

Layer A: TD 110 BF, extruder feed rate 25 rpm;

Layer B: HP 522 H, extruder with melting pump, feed rate 35 rpm;

Layer C: HP 522 H, core extruder with melting pump, feed rate 46 rpm;

Layer D: 50% Bynel 50 E 739 and 50% HP 522 H; extruder with melting pump, feed rate 8 rpm;

Layer E: PA 3426; extruder feed rate 12 rpm.

The primary film obtained on the chill roll was stretched simultaneously 8.6× in MD and 7× in TD, a film 20 μm thick being obtained. The thickness of the polyamide layer (layer E) was approximately 0.6 μm.

The S-BOPP film produced in a width of 800 mm in Example 6 had a better general appearance than the foils produced in the preceding Examples 1 to 5 since no further stripes were observed. The surface tension of the external PA layer was determined as approximately 50 dynes/cm.

### Example 7

The film was produced as in Example 6, except that the LISIM® stretching system was adjusted so that stretching to 7.5× was carried out in TD, and the finished S-BOPP film had a width of 900 mm. A roll 4000 m long was produced.

### Example 8

The film was produced as in Example 7 and a 8000 m long roll was produced for metallizing purposes, the surface of the external polyamide layer (layer E) being subjected to a flame treatment over the last 2000 metres of the film under conditions normal for BOPP films.

The flame treated surface had a surface tension of over 55 dynes/cm.

The film produced in Example 8 was vacuum coated in the normal way with aluminum vapor so that the optical density was 2.3. Here the polyamide surface of the film was pretreated in a different way before metallisation, as follows:

| | |
|---|---|
| 1200 m | were subjected to a flame treatment and an in-vacuum |
| | plasma treatment; |
| 800 m | were subjected exclusively to a flame treatment; |
| 4500 m | were not additionally treated; and |
| 1500 m | were subjected exclusively to an in-vacuum plasma |
| | treatment. |

The results of the metallisation after the different pretreatments are listed in the attached table at the end according to Example 18.

### Example 9

The film was produced as in Example 8, except that the entire 2000 metres of the external PA layer (layer E) were subjected to a flame treatment under the conditions normal for BOPP films.

### Example 10

The film was produced as in Example 7, except that the thickness of the PA layer (layer E) was increased to approximately 1.2 μm.

The films produced in Examples 7, 9 and 109 were combined on a cutting machine to form a composite roll and subjected to a vacuum coating with a clear ceramic barrier coating (SiOx) under identical conditions.

### Example 11

The film was produced as in Example 7, except that during the simultaneous stretching the elongation ratio was 9 in MD and 7.5 in TD, and the feed rate of the extruder for the core layer was adjusted so that a total film thickness of 12 μm was obtained, the thickness of the polyamide layer (layer E) being approximately 0.75 μm.

### Example 12

The foil was produced as in Example 11, except that the system speed and the feed rate of the core extruder were adjusted so that a film with a total thickness of 15 μm was obtained, the feed rate of the extruder for layer E being adjusted to 24 rpm, which produced a PA layer thickness of 0.65 μm.

### Example 13

In this example and the next two Examples 14 and 15 the thickness of the polyamide layer (layer E) was varied in order to determine the influence of the thickness of the PA layer on the printability and writeability of the multilayer film.

In Example 13 the film was produced as in Example 12, except that the thickness of the polyamide layer (layer E) was increased to approximately 0.38 μm by increasing the feed rate of the extruder to 12 rpm.

### Example 14

The film was produced as in Example 11, except that the thickness of the polyamide layer (layer E) was reduced to approximately 0.2 μm by reducing the feed rate of the extruder for layer E to 6 rpm.

### Example 15

The film was produced as in Example 11, except that the thickness of the polyamide layer was reduced further by reducing the feed rate of the extruder for layer E to only 3 rpm.

The S-BOPP films obtained, with a thickness of 15 μm, had good uniform surface coverage due to the very thin layer of less than 0.1 μm of the low-crystalline polyamide.

All 5-layer films in Examples 1 to 15 had a high surface tension and excellent optical properties and strength properties, which are shown in the table.

### Before Example 16

7-layer films with a wide slot die 400 mm wide were produced in the following examples using the above 5 extruders.

layer A: two-screw co-extruder for extruding 1 μm TD 120 BF, corona treated;

layer B: two-screw co-extruder: HP 522 H with additives;

layer C: 35 mm single screw extruder: adhesive layer 1 μm thick from 50% HP 522 H/50% Bynel 50 E 739;

layer D: 35 mm single screw extruder: polyamide barrier;

layer E: same extruder and same material as layer C:

layer F: same extruder and same material as layer B:

layer G: 50 mm single screw extruder with melting pump, extrusion of a layer of 1 μm TD 110 BF.

### Example 16

A film with the 7-layer structure already described was extruded and the primary film formed on the chill roll was stretched 8.5× in MD and 5.5× in TD, a film with a thickness of 20 μm being obtained which at its center had a PA barrier (layer D) with a thickness of 1.45 μm.

### Example 11

The film was produced as in Example 16, except that the feed rate of the extruder for the polyamide barrier (layer D) was increased so that a layer thickness of 1.75 μm was obtained.

### Example 18

The film was produced as in Example 17, except that the feed rate of the extruder for the polyamide barrier (layer D) was further increased so that a barrier with a thickness of 2.15 μm was obtained.

### Results

The properties of the films produced in Examples 1 to 18, where they were measured, are reproduced in the following table.

The results of the film production tests described in the examples clearly show that according to this invention BOPP films with excellent barrier properties and a combination of further excellent properties desirable for packing purposes are obtained, as were very good film strengths, rigidities, excellent optical properties with excellent properties in terms of aroma and odor tightness and excellent other barrier properties shown in the table.

Here, values of approximately 140 N/mm² (MD) and 280 N/mm² (TD) can be used as comparative values for typical BOPP films obtained by sequential stretching, values ranging from 150-250% (MD) and 50-60% (TD) for elongation at rupture and values ranging from 2000-2200 N/mm² (MD) and up to 3800 N/mm² (TD) for the modulus of elasticity.

It must be pointed out that the aroma and odor tightness is also observed for films which have neither metallisation nor a ceramic coating. The range of the production conditions indicated in the examples is limited only by the equipment made available during the tests, but the method conditions indicated do not represent the limits of this invention or the method for producing the films according to the invention. For example, thicknesses of the barrier of up to 10 μm may be obtained depending on the intended applications of the films, particularly for the barrier arranged in the core if this is desirable.

It must also be pointed out that the conditions of the simultaneous stretching can be controlled so that the films obtained are subjected to a stabilization enabling them to display a dimensional stability at which a shrinkage of 5% or less is obtained in one or both of its main directions, the MD or TD of their production. However, stretching conditions may also be selected so that the shrinkage in one or both directions is as much as 20% at 135° C.

It must also be pointed out that in the case of the 7-layer structure, as is described in Examples 16 to 18, one of the polypropylene layers can be produced by using polypropylene regenerate or by using polyolefins, which are different from the polypropylene used for the other layer (layer B), and depending on the end use employed, wherein the fact is made use of that all the requirements of cleanliness with regard to the other side of the film remain guaranteed by means of the central PA barrier.

In addition to the film properties which are reproduced in the table, it must be pointed out that some of the values indicated vary during the ageing of the films, it being particularly important to increase the values for the modulus of elasticity by approximately 30% within 60 days of production. It is also important for the surface tension of the treated and untreated film according to the invention, in which the PA barrier represents an external layer, remains essentially constant over time, which represents a considerable advantage over normal BOPP films in which the surface tension varies relatively quickly over time after a surface treatment (flame treatment; plasma treatment).

Films according to the invention must not therefore be coated immediately (metallized, ceramic coated) and the coating may be carried out as required using stored finished films.

Because of the excellent barrier properties the films are suitable for all packing purposes where it is important for the packed product not to suffer a loss of aroma and/or for no aroma to develop through the packaging material. The oxygen and water vapor transmission rates of the films according to the invention are such that they are suitable for most applications for which currently the more expensive coated polyester films, which are heavier due to their higher density, have to be used.

Particularly preferred applications are applications for the packaging of food products, for example fresh food, confectionery, cakes and pastries, and of beverages and tobacco, including, for example, coffee, tea and tobacco products. The films may also be sued for the packaging of other products, e.g. pharmaceuticals. Because of the cellophane-like appearance and their grip, the films may also be used for all applications in which the consumer expects cellophane type materials. Because of their good printability the films according to the invention are also excellent for packaging materials of all kinds designed for advertising.

1. A barrier film for packing purposes, in particular for the packing of food products, beverages and tobacco, embodied in the form of a multilayer film based on at least one carrier layer in the form of a biaxially orientated polypropylene film (PP film) with at least one co-extruded functional layer on the basis of an amorphous or partially crystalline polyamide (PA) or a mixture of such a polyamide with ethylene vinyl alcohol copolymers (EVOHs),
wherein it is produced by simultaneous stretching of a coextruded multilayer primary film, wherein the functional PA layer forms an external layer of the film.

2. The high-strength brilliant barrier film for packing purposes, in particular for the packing of food products, embodied in the form of a multilayer film on the basis of at least one carrier film in the form of a biaxially orientated polypropylene film (PP film) with at least one co-extruded functional layer on the basis of an amorphous or partially crystalline polyamide (PA) or a mixture of such a polyamide with ethylene vinyl alcohol copolymers (EVORs),
wherein it is produced by simultaneous stretching of a coextruded multilayer primary film, in which the functional PA layer forms a central internal layer of the film which is arranged between two carrier layers.

3. The film as claimed in either of claims 1, wherein the tensile strength of the film and its modulus of elasticity in the machine direction (MD) and its elongation at rupture in the transverse direction (TD) are the same or higher than in TD and MD respectively.

4. The film as claimed in either of claims 1, wherein the sum of the moduli of elasticity in the longitudinal and transverse directions exceeds 3500 N/mm², preferably 4500 N/mm².

5. The film as claimed in claim 3, wherein its tensile strength (ASTM D 822) in MD ranges from 170-280 N/mm² and in TD ranges from 130-215 N/mm².

6. The film as claimed in claim 1, wherein its elongation at rupture (ASTM D 82) in MD ranges from 50-120% and in TD from 100-220%.

7. The film as claimed in claim 1, wherein it has a gloss (gloss; ASTM 2457) of over 100.

8. The film as claimed in claim 1, wherein it has a metallization or a clear SiOx or AlOx ceramic coating on the PA barrier and wherein its oxygen transmission rate (0 Th) at 23° C. and 75% relative humidity is below 0.50 cm³/(m² datm), in particular below 0.20 cm³/(m² datm and its water vapor transmission rate (WVTR; ASTM E 96) is below 0.5 g/(m²d) under tropical conditions (38° C.; 90% relative humidity).

9. The film as claimed in claim 1, wherein its layer structure is at least three-layer and incorporates a PP carrier layer, an adhesion layer arranged on it and an external PA barrier arranged over the adhesion layer.

10. The film as claimed in claim 9, wherein it has at least four layers and at least one further layer, which is heat-sealable, on the side of the PP carrier layer facing away from the PA barrier.

11. The film as claimed in claim 2, wherein its layer structure has at least five layers and the sequence of the layers comprises a first PP carrier layer, a first adhesion layer, a PA barrier, a second adhesion layer and a second PP carrier layer.

12. The film as claimed in claim 11, wherein it also has an external thermoplastic layer suitable for a corona or plasma treatment over the first PP carrier layer and/or a heat-sealable thermoplastic external layer over the second PP carrier layer.

13. The film as claimed in claim 12, wherein one of the PP carrier layers contains a regenerate-PP.

14. The film as claimed in claim 9, wherein the adhesive layers of PP adjacent to the PA barrier are formed, which PP is modified by mixing with an anhydridemodified PP, a polyethylene copolymer or an anhydridemodified acrylic resin, in which the quantity of PP in the adhesive layer is up to 75% by weight.

15. The film as claimed in claim 1, wherein the thickness of the PA barrier lie3 within the range of 0.1 to 10 μm.

16. The film as claimed in claim 1, wherein the thickness of the PA barrier lies within the range of 0.1 to 5 μm.

17. The film as claimed in claim 2, wherein the thickness of the PA barrier arranged on the inside of the multilayer film lies within the range of 0.5 to 10 μm.

18. The film as claimed in claim 1, wherein the thickness of the film lies within the range of 8 to 80 μm.

19. The film as claimed in claim 1, wherein one or more of the PP carrier layer(s), the adhesive layer(s) and/or the barrier contain/contains additives which are selected from a group which comprises the mineral or organic additives for forming micro-cavities, fillers, absorption agents, UV and light screening agents, dyes and covering pigments.

20. The film as claimed in claim 1, wherein it may be obtained by a method for producing a barrier film for packing purposes.

21. A method for producing a barrier film for packing purposes as claimed in claim 1, wherein the polymers forming the layers of the multilayer film are co-extruded as melts from the required number of wide slot dies on a chill roll and wherein the primary multilayer film formed is subject to non-contact simultaneous stretching with a surface increase of 40 to 80 times on a simultaneous stretching system with a linear motor operation (LISIM®) or on a mechanical simultaneous stretching system.

22. The method as claimed in claim 21, wherein the primary multilayer film in the machine direction (MD) is stretched to at least 6 times its length.

23. The method as claimed in claim 22, wherein the primary multilayer film is stretched simultaneously in MD to at least 7 times and in the transverse direction (TD) to less than 7 times.

24. The method as claimed in claim 22, wherein the primary multilayer film is stretched simultaneously in MD to more than 8 times, preferably to at least 9 times and in TD to less than 8 times.

25. The method as claimed in claim 21, wherein the PA layer is co-extruded as the external layer of the primary film which is in direct contact with the chill roll.

26. The method for producing a barrier film for packing purposes as claimed in claim 1, wherein the polymers forming the layers of the multilayer film are co-extruded as melts from an annular die and are subjected to simultaneous stretching by the BUBBLE or DOUBLE BUBBLE method, in which the area is increased to 40 to 80 times.

27. An application of a barrier film as claimed in claim 1 as aroma, odor and oxygen-tight packing film for food products, beverages and tobacco.

28. The application as claimed in claim 26 of a barrier film with a clear SiOx or AlOx ceramic coating for the production of aroma, odor and oxygen-tight transparent packaging materials for food products, beverages and tobacco.
